(19) United States
(12) Patent Application Publication
(10) Pub. No.: US 2005/0077670 A1
(43) Pub. Date: Apr. 14, 2005

(54) Product delivery loader and its use

(75) Inventors: William T. Graushar, Elm Grove, WI (US); Jim Bartlett, Hartford, WI (US); John Geres, West Allis, WI (US); Mike Heppe, Waterford, WI (US)

Correspondence Address: MICHAEL BEST & FRIEDRICH, LLP, 100 E WISCONSIN AVENUE, MILWAUKEE, WI, 53202, US

(73) Assignee: Quad/Graphics, Inc., Sussex, WI (US)

(21) Appl. No.: 10/684,920

(22) Filed: Oct. 14, 2003

(51) Int. Cl. B42B 2/00

(52) U.S. Cl. 270/52.16

(57) ABSTRACT

A loader operable to deliver product to a process line. The loader including a buffer section operable to support a printed product and a transfer section operable to receive printed product from the buffer section. One of a plurality of interchangeable nose sections is coupled to the transfer section to receive the printed product and deliver the printed product to the process line. The loader is engageable with a support post of a finishing line to align the loader with respect to the finishing line and/or to supply production support to the loader.

### BACKGROUND OF THE INVENTION

The invention relates to a product delivery loader, and more particularly, to a loader for a process line. Specifically, the present invention relates to a product delivery loader for use with various types of finishing equipment and/or for use with a support post.

Loader development for bindery equipment has been ongoing with its goal to reduce labor costs and increase productivity. Loaders were mainly developed to feed pockets. Pockets are the means used to deliver signatures to a binding line. Pockets typically sit on a base. The base needed to physically support the pocket and position them for the collating process. The base is also a vehicle for production needs including electrical, compressed air and vacuum requirements. As such, the base can be a complicated construction that is quite costly. Furthermore, the pockets themselves are generally designed to operate with a wide range of printed product sizes. Thus, when using a more standard sized printed product, the additional capabilities, and with them complications, of the pocket become unnecessary.

On perfect binding lines, printed product is fed directly to a gathering trough. Perfect binder feeders are often designed with capabilities that allow for their use with a wide range of printed product sizes. Thus, when operating with standard sized printed product, the enhanced capabilities of the feeder are unnecessary.

Other printing and binding processes include feeders. As just described, each of these feeders generally includes a feeder-specific device that is operable to deliver printed product to the feeder. As such, a bindery or printing facility may have many different feeder-specific devices each requiring spare parts and maintenance, thus increasing the costs of operation.

### SUMMARY OF THE INVENTION

The invention provides a loader operable to deliver product to a process line. The loader includes a buffer section operable to support a product and a transfer section operable to receive the product from the buffer section. One of a plurality of interchangeable nose sections is coupled to the transfer section to receive the product and deliver the product to the process line.

In another embodiment, the invention provides a process line operable to assemble a plurality of printed products. The process line includes a support post and a loader operable to deliver printed product to the process line. The delivery loader is coupled to the support post. A conveyor is positioned to receive and transport the printed product from the loader.

In another embodiment, the invention provides a process line comprising a conveyor and a plurality of loaders operable to deliver product to the conveyor. A support post is positioned adjacent the conveyor and operable to selectively receive the plurality of loaders and align each loader with the conveyor.

The invention provides a method of arranging a process line including a conveyor operable to move product. The method includes positioning a support post adjacent the conveyor line. The method also includes coupling a loader to the post such that the loader is operable to deliver product to the conveyor.

In another embodiment, the invention provides a support post positioned adjacent a conveyor of a finishing line. The post includes an alignment member positioned a distance from the conveyor, the alignment member engages and aligns the loader relative to the conveyor.

In another embodiment, the invention provides a support post positioned adjacent a conveyor of a finishing line. The post includes an alignment member that engages a loader and a production supply line. The production supply line is operable to provide at least one of pressurized air, vacuum, power and communications to the loader.

Other features and advantages of the invention will become apparent to those of ordinary skill in the art upon review of the following detailed description, claims, and drawings.

### BRIEF DESCRIPTION OF THE DRAWINGS

FIG. 1 is a perspective view of a delivery loader without a nose portion;

FIG. 2 is another perspective view of the delivery loader of FIG. 1;

FIG. 3 is a schematic illustration of a portion of a signature travel path of the loader of FIG. 1;

FIG. 4 is a schematic perspective view of the delivery loader of FIG. 1 with a nose for a saddle stitcher attached;

FIG. 5 is a perspective schematic view of the delivery loader of FIG. 4 positioned adjacent a collating chain and a support post;

FIG. 6 is a perspective view of the delivery loader of FIG. 1 with a perfect binder nose attached;

FIG. 7 is a perspective schematic view of the delivery loader of FIG. 6 positioned adjacent a perfect binder line and the support post;

FIG. 8 is a perspective schematic of the delivery loader of FIG. 1 with an offline mailer nose attached;

FIG. 9 is a perspective schematic of the delivery loader of FIG. 1 with an inkjet pocket nose attached;

FIG. 10 is a perspective schematic view of the support post;

FIG. 11 is a perspective schematic view of several loaders of FIG. 7 positioned adjacent the support post;

FIG. 12 is a perspective schematic view of a speed follower adjacent the support post; and

FIG. 13 is an elevational view of a connection point of the support post.

Before one embodiment of the invention is explained in detail, it is to be understood that the invention is not limited in its application to the details of construction and the arrangement of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION

Before describing the invention in detail it should be noted that the invention will function with many different types of printed or non-printed products, with signatures being but only one type of printed product. Therefore, while the term “signature” is used throughout the description, the invention should in no way be limited to use with signatures alone. Furthermore, signatures are described herein as including four edges and two faces. It should be understood that one or more edges may actually be folds. Therefore, the term “signature” should not be limited to a single sheet of paper, nor should it be limited to a single folded piece of paper as the device described herein will also function with nested folded sheets of paper.

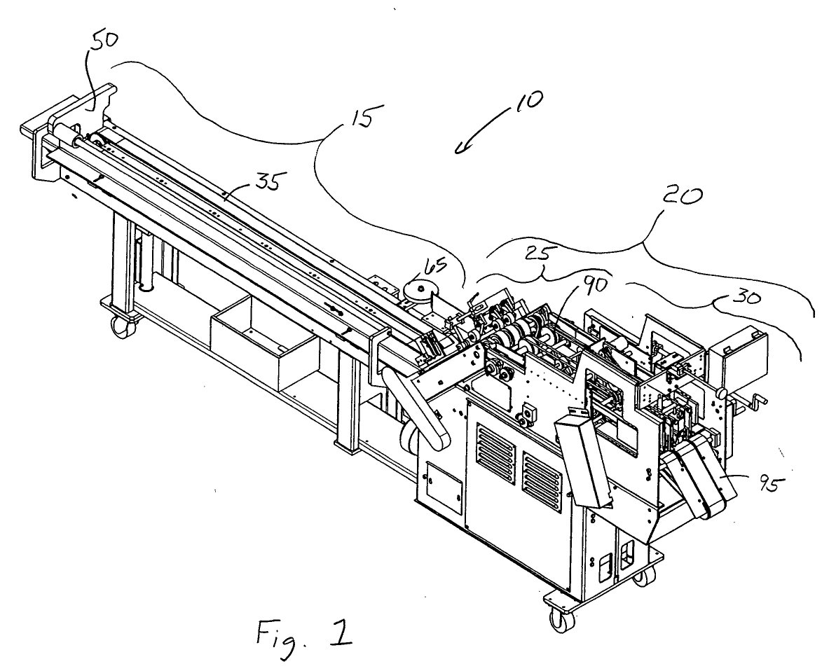

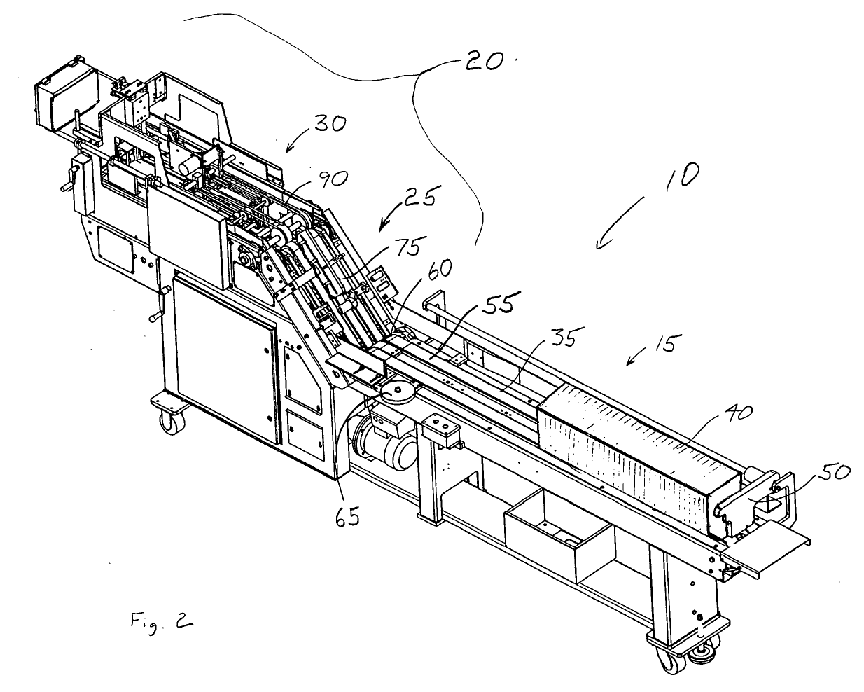

Referring now to the drawings, there is shown in FIGS. 1 and 2 a delivery loader 10 for a saddle stitcher, perfect binder, and/or other finishing or processing equipment. The loader 10 includes a buffer section 15, and a transfer section 20 having a preparation section 25 and a delivery section 30.

The buffer section 15 includes a substantially horizontal portion 35 that is large enough to support at least one log 40 of product, such as a log of signatures destined for a binding line. The log of signatures 40 is placed on the horizontal portion 35 between the already present signatures and a movable end plate 50. The movable end plate 50 provides support to the end signatures so that they remain in the desired position as they are delivered to the preparation section 25.

The horizontal portion 35 may include one or more rails (not shown) that support the log 40 at a desired height and a conveyor 55 disposed beneath the signatures and operable to move the signatures in a desired direction. The rails, if used, act to reduce the friction between the horizontal portion and the signatures, thereby making it easier to move the signatures smoothly along the desired path without damage. The conveyor 55 engages the bottom surface of the log 40 and moves it toward the signature preparation section 25.

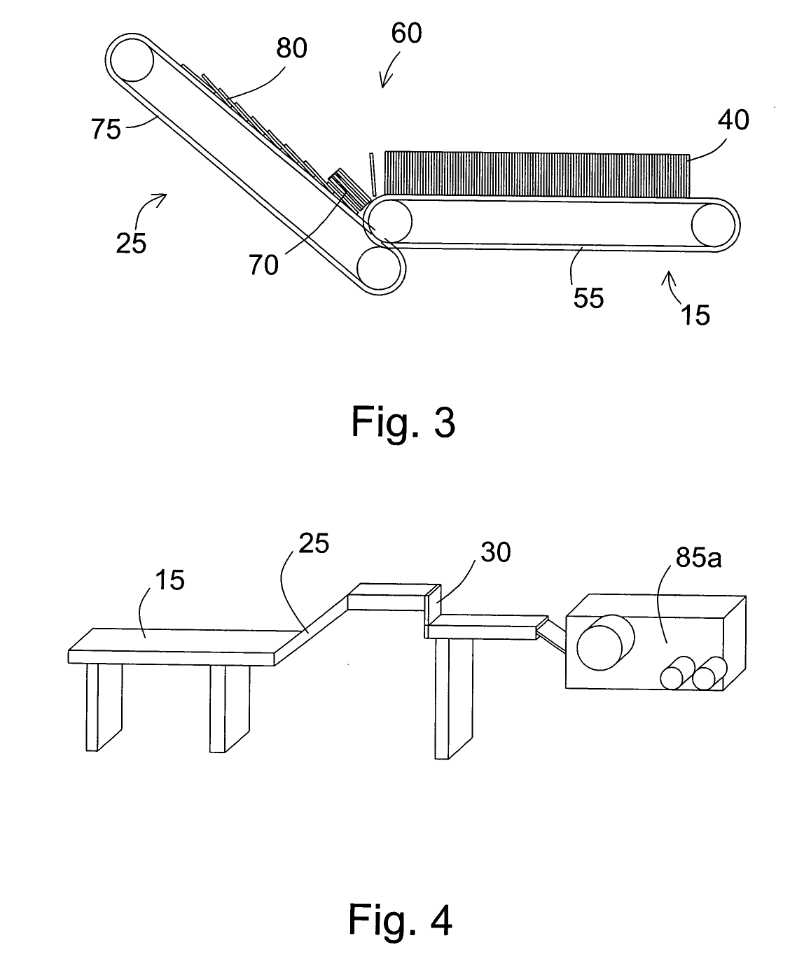

The buffer section 15 includes a waterfall portion 60 disposed between the horizontal portion 35 and the preparation section 25. The waterfall portion 60 receives signatures from the horizontal portion 35 and reorients them for delivery to the preparation section 25 (best illustrated in FIG. 3). The signatures support one another on an edge as they approach the waterfall portion 60. The waterfall portion 60 directs the signatures along a slight downward path to allow the top edge to fall over the bottom edge such that the signatures are supported on a face rather than an edge. The waterfall portion 60 aids in the separation of the signatures and reduces the amount of static electricity and vacuum adhesion present between adjacent signatures. To further aid in the separation of signatures, other devices may be located at various positions within the loader 10. For example, FIGS. 1 and 2 illustrate a wheel 65 supported for rotation along an axis perpendicular to the travel direction and adjacent the signature log 40. The wheel 65 engages the signatures of the log 40 as they pass and displaces them slightly relative to one another. The displacement breaks the vacuum adhesion and the static electricity bond to aid in signature separation. Other systems and methods of separating signatures are known and will function with the loader 10 illustrated herein.

The large buffer provided by the buffer section 15 increases the time interval for tending to the loader 10. As such, a single worker is able to tend several loaders 10 where the same worker may have only been able to tend one or two prior loaders. Thus, use of the loader 10 described herein reduces the labor requirements associated with tending loaders 10.

The preparation section 25, illustrated in FIG. 3, includes a queue 70 and a conveyor 75. The queue 70 receives signatures from the buffer section 15 and holds them until the conveyor 75 moves them to the delivery section 30. The signatures are preferably supported in a substantially face down orientation in the queue 70. In many constructions, the speed of the conveyor 55 is controlled to maintain a desired quantity of signatures in the queue 70. For example, height or weight sensors can be used to determine the approximate quantity of signatures in the queue 70. When the quantity is low, the conveyor 55 speeds up to replenish the queue 70. When the quantity is high, the conveyor 55 slows or stops to allow the conveyor 75 to deplete the queue 70.

The preparation conveyor 75 engages the bottommost signature in the queue 70 and transports it toward the signature delivery section 30. As each signature progresses, the adjacent signature is transported, thus establishing a shingled stream of signatures 80. The preparation section 25 transports signatures up an inclined slope. However, it should be understood that flat preparation sections 25 as well as preparation sections 25 that transport the signatures down a slope are possible and contemplated by the present invention.

The delivery section 30 shown in FIGS. 1 and 2 receives the shingled stream of signatures 80 from the preparation section 25, individualizes them, orients them, and delivers them to a nose section which will be discussed in more detail below. It should be noted that in some constructions, the preparation section 25 may individualize the signatures and deliver them individually to the delivery section 30, rather than delivering them as a shingled stream of signatures 80.

The delivery section 30, illustrated in FIG. 1 and 2, includes a first conveyor 90 positioned to receive signatures from the preparation section 25 and a second conveyor 95 positioned to deliver signatures to the nose portion. The first conveyor 90 operates at a higher speed than the preparation conveyor 75 to facilitate an increased spacing between signatures. In another construction, the shingled stream of signatures 80 is delivered to a second queue located within the delivery section 30 adjacent the second conveyor 95. The second conveyor 95 then operates to deliver one signature at a time to the nose section.

The delivery section 30, in addition to individualizing the signatures, orients and aligns the signatures for delivery to the nose section. For example, a particular process may require the signatures to be inverted or rotated relative to their initial orientation. This adjustment to the orientation of the signatures is performed within the delivery section 30. Furthermore, many processes may require that each signature be precisely positioned (registered) before delivery to the nose section. This registration process may also be accommodated within the delivery section 30.

The second conveyor 95, illustrated in one possible orientation in FIG. 1, delivers the individualized signatures to the nose section or cooperates with the nose section to deliver the signatures to the binding line or other process equipment. The second conveyor 95 can be repositioned to accommodate any one of many noses that may attach to the loader 10. As such, the loader 10 is well suited to delivering product to many different processes or different binding lines.

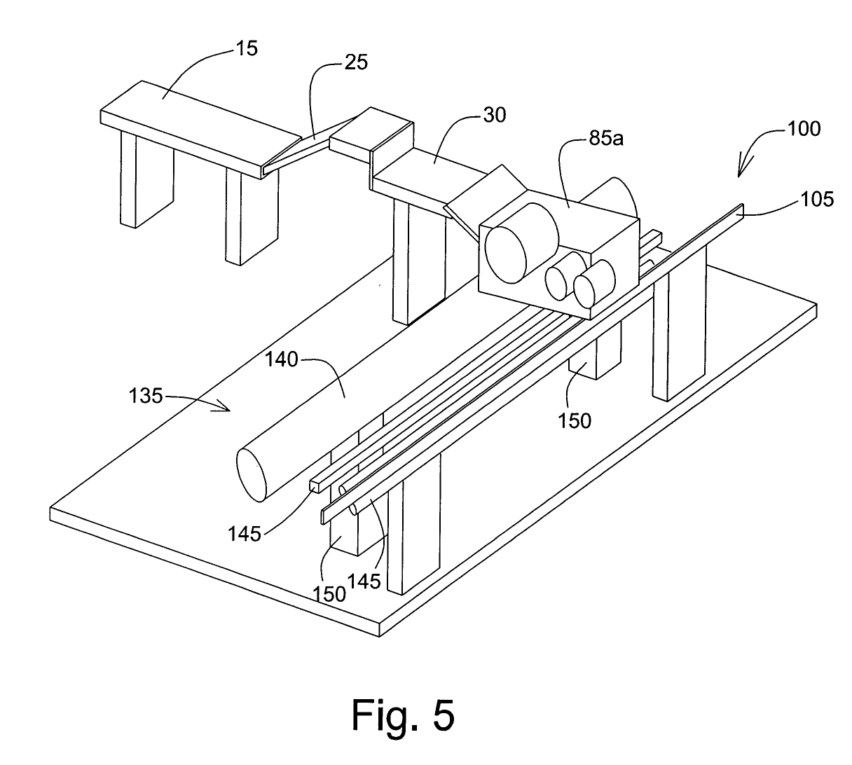

For example, FIGS. 4 and 5 schematically illustrates the loader 10 supporting a nose 85a suited for delivering signatures to a saddle stitcher 100. The nose 85a is a pocket that functions in a manner similar to pockets currently used in saddle stitching. The nose 85a receives the individual signatures from the second conveyor 95 and deposits the signature onto a gathering chain 105.

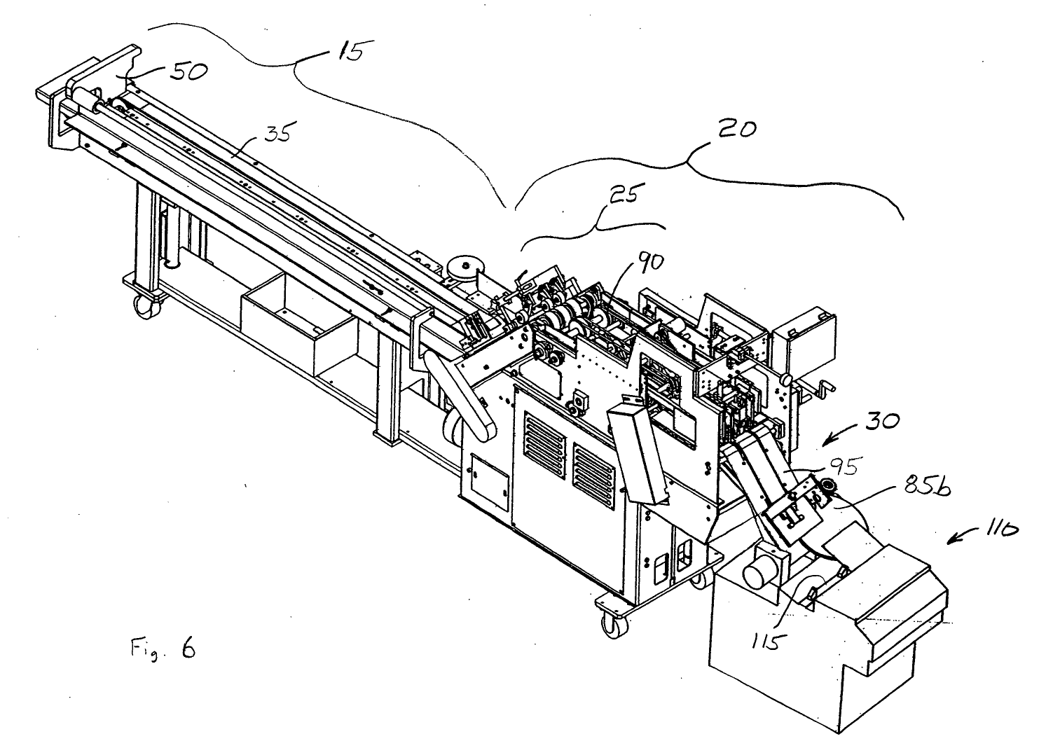

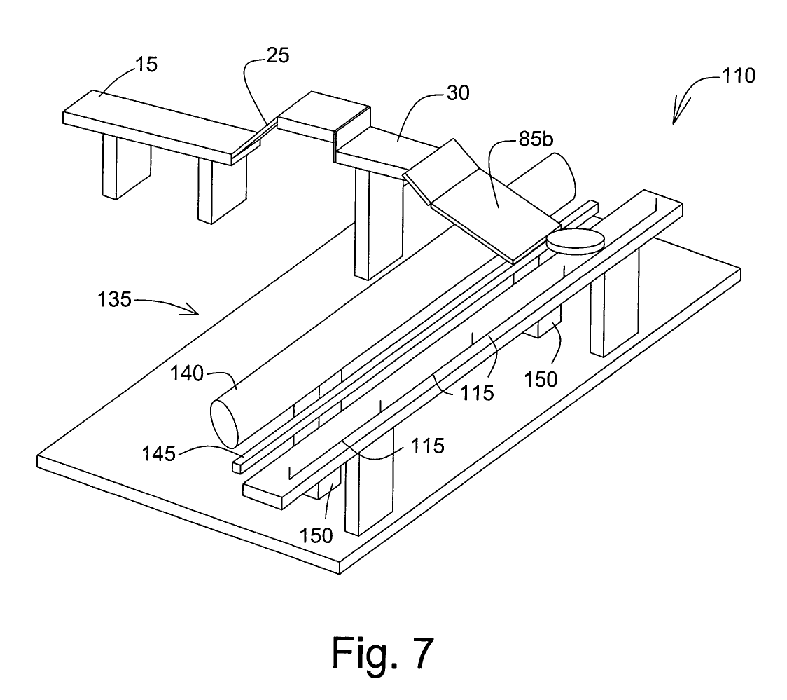

Turning to FIGS. 6 and 7, the loader 10 is illustrated as supporting a nose 85b adapted for delivering printed product to a perfect binder line 110. The perfect binder nose 85b engages the signature at the end of the second conveyor 95 and delivers it into a trough 115 on the perfect binder gathering line 110.

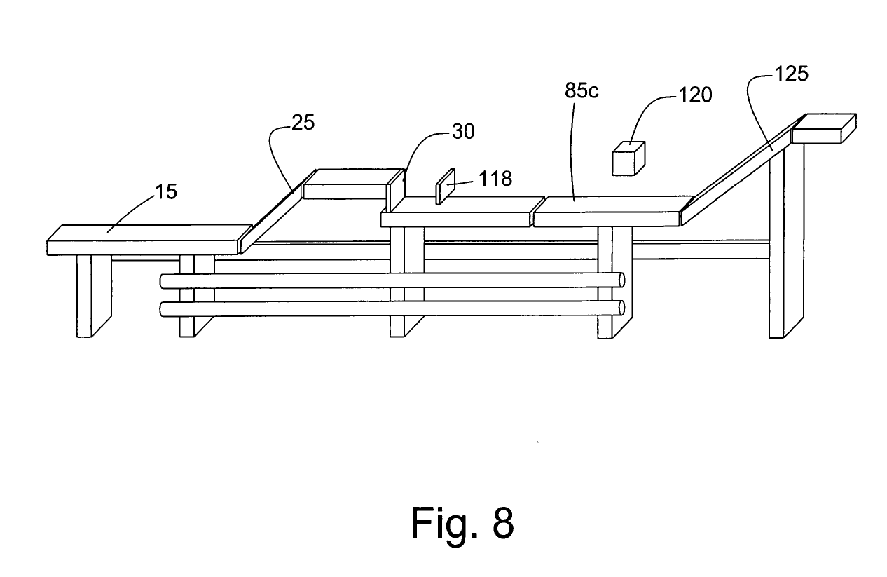

In addition to use with a perfect binder 110 and a saddle stitcher 100, the delivery loader 10 can be used in other finishing or processing areas such as an offline mailer, a poly wrapper loader/feeder, and a printing platform. For example, the loader 10 as used in an offline mailer 120 is illustrated in FIG. 8. The loader 10 includes the buffer section 15, the preparation section 25, the delivery section 30, and an offline mailer nose 85c. Signatures in the form of logs are placed in the buffer section 15. The signatures are individualized by the loader 10 as they move toward the delivery section 30. Within the delivery portion 30, a registration section 118 aligns and positions each signature so that the desired print can be accurately located. The now registered signature moves to the offline mailer nose 85c where a printer 120, such as an inkjet printer or other printing device on a print platform 122, prints the desired text and/or image onto the signature. The nose 85c then delivers the signature to a stacker 125 to restack the product for later use.

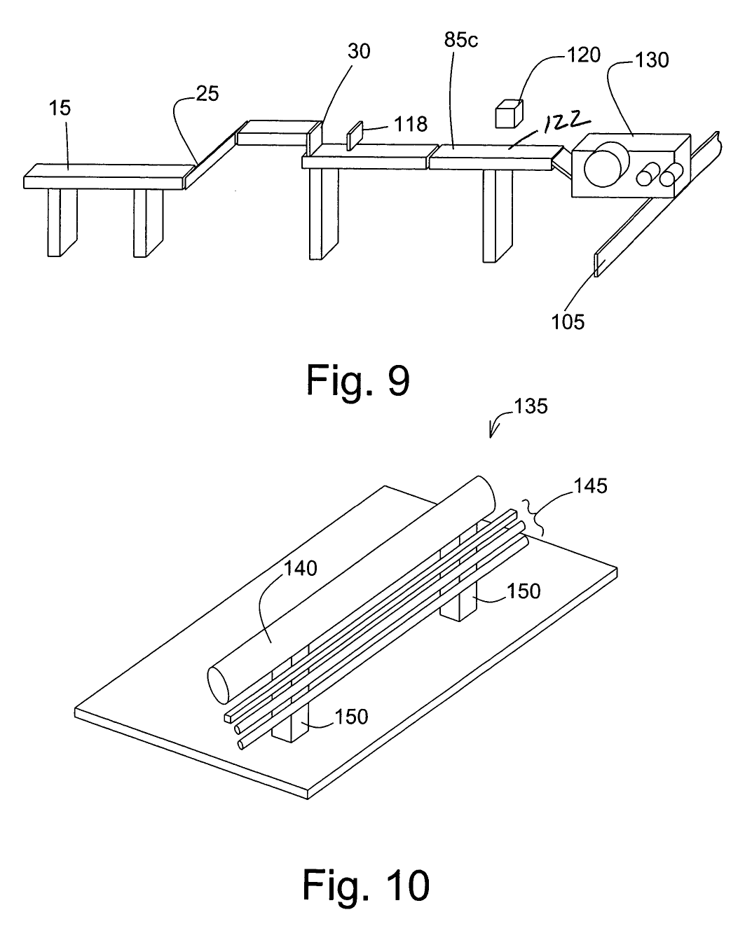

In another construction illustrated in FIG. 9, the signature is delivered to a pocket 130 and then to the gathering chain 105 for binding. In still other constructions, the completed signature is delivered to other process equipment for immediate use via another nose type (e.g., saddle stitch nose, perfect binder nose, wrapping nose, cartoning nose or tipping nose).

The delivery loader 10 of the present invention can be used with a variety of other applications e.g., wrapping, cartoning, tipping, inserting, and the like. In a cartoning application, a delivery loader 10 delivers a single piece into a carton. In a tipping application, the delivery loader 10 tips a piece onto a book. In an inserting application, the delivery loader 10 inserts a piece into an inserter raceway as in an envelope-inserting machine. The loader 10 eliminates the need for traditional pockets 130 and bases.

Turning now to FIG. 10, the delivery loader 10 is coupled to a finishing line via a support post 135. The support post 135 includes an alignment member 140, a plurality of process support lines 145, and legs 150. The post 135 is positioned adjacent the binding or other process line and facilitates the proper positioning of loaders 10. The alignment member 140 engages or abuts each loader 10 at a desired hitch location to position the loader 10 with respect to the binding line or other process line.

Loaders 10 and the noses 85 attached thereto require process support supplies such as power, vacuum, high-pressure air, low-pressure air and communications. The process support lines 145 preferably extend along the length of the post 135 and include various connection points that allow for the quick and easy connection of the loader 10. As shown in FIG. 13, in most constructions, the loader 10 requires only one air connection 160, one vacuum connection 165, and one power/communications connection 170. Transformers, pressure-reducing valves, and other piping components connect these supplies as needed throughout the loader 10. As such, the loader 10 can be quickly aligned and coupled to the post 135. This in turn reduces down time and improves plant efficiency. Other loader constructions may require additional connections and as such are contemplated by the present invention.

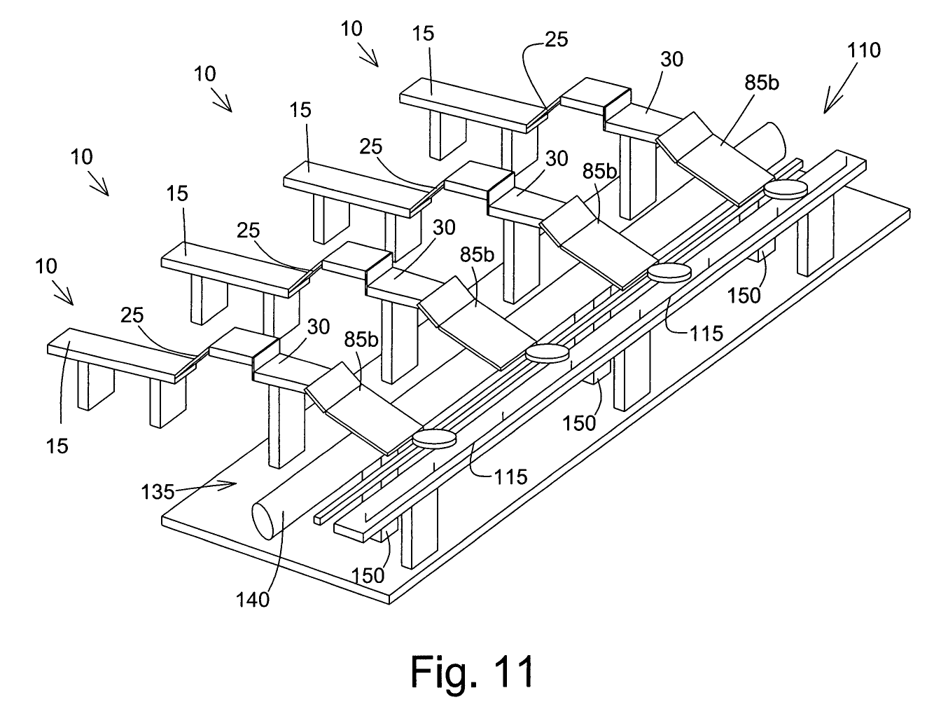

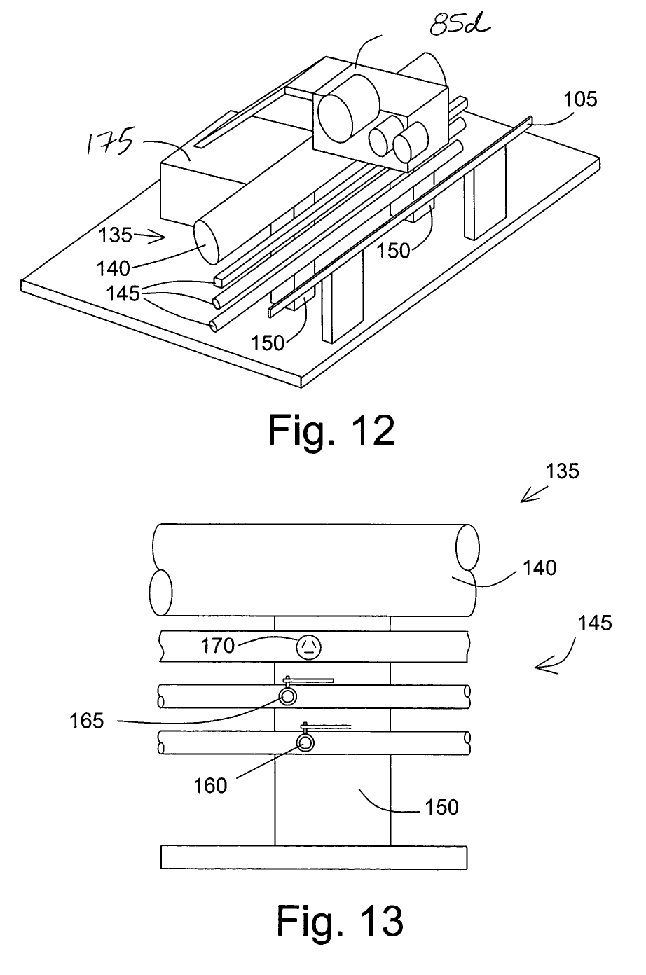

FIG. 11 shows a portion of the perfect binder line 110 including several loaders 10, each loader 10 including the perfect binder nose 85b. As illustrated, each loader 10 abuts the post 135 to position the nose 85b over the gathering trough 115. Power, communications, air, and vacuum are supplied to each loader 10 via the post 135. As shown in FIGS. 12 and 13, connection points distributed along the length of the post 135 allow for the connection of the loaders 10. Because the loader 10 supports the nose 85b and power, communications, air, and vacuum are supplied via the post 135, the base normally associated with a pocket or perfect binder is unnecessary and eliminated.

Certain pieces of equipment such as the loaders 10, pockets 85a, perfect binder noses 85b, or other components may be ill suited to certain types or sizes of product. While the loader 10 and noses 85 described herein are intended to be used with a vast majority of the known products, it is possible that some feature of a certain product will make its use with the above-described loader 10 and noses 85 undesirable. In that situation, a speed following stand 175 may be used as shown in FIG. 12. The speed following stand 175 engages the post 135 and receives process support from the post 135 in much the same manner as the loader 10. However, the speed following stand 175 supports a nose 85d that is suited for the delivery of the particular product. For example, the speed following stand 175 supports a pocket 85d adjacent the gathering chain 105. The speed following stand 175 follows the gathering chain speed so that the pocket 85d remains synchronized with the gathering chain 105 for the collating process. The speed following stand 175 abuts the post 135 to place the pocket 85d in the proper position for collating. In addition, the speed following stand 175 taps into the electrical, compressed air communication and vacuum supports of the post 135 to facilitate the speed following stand's operation.

Although the invention has been described in detail with reference to certain preferred embodiments, variations and modifications exist within the scope and spirit of the invention as described and defined in the following claims.

1. A loader operable to deliver product to a process line, the loader comprising:
a buffer section operable to support a product;
a transfer section operable to receive the product from the buffer section; and
one of a plurality of interchangeable nose sections coupled to the transfer section to receive the product and deliver the product to a process line.

2. The loader of claim 1, wherein the process line is a gathering line including a saddle stitcher and wherein the nose section includes a pocket operable to deliver the product to the gathering line.

3. The loader of claim 1, wherein the process line is a binding line including a perfect binder and wherein the nose is a binder nose operable to deliver product to a gathering raceway.

4. The loader of claim 1, wherein the process line is an offline mailer and wherein the nose includes a registration portion.

5. The loader of claim 1, wherein the process line is an offline mailer and wherein the nose section includes a printer.

6. The loader of claim 1, wherein the buffer section includes a substantially horizontal platform.

7. The loader of claim 6, wherein the platform is sized to receive at least one log of product.

8. The loader of claim 1, wherein the buffer section includes a waterfall portion operable to transfer the product from a first orientation to a second orientation.

9. The loader of claim 8, wherein the product includes an edge and a face and when in the first orientation, the product is supported on the edge and when in the second orientation, the product is supported substantially on the face.

10. The loader of claim 1, wherein the transfer section includes a delivery section operable to deliver product to the nose section.

11. The loader of claim 10, wherein the delivery section at least partially supports the nose section.

12. The loader of claim 1, further comprising a support post adjacent the process line, the post including a hitch location, and the loader being alignable with the hitch location to position the nose section such that the nose section delivers product to the process line.

13. The loader of claim 12, wherein the post includes connections to a production support supply.

14. A process line operable to assemble a plurality of printed products, the process line comprising:
a support post;
a loader operable to deliver printed product to the process line, the loader coupled to the post; and
a conveyor positioned to receive and transport the printed product from the loader.

15. The process line of claim 14, wherein the loader includes a buffer section operable to support a printed product, a transfer section operable to receive the printed product from the buffer section, and one of a plurality of interchangeable nose sections coupled to the transfer section to receive the printed product and deliver it to the process line.

16. The process line of claim 15, wherein the process line is a gathering line including a saddle stitcher, wherein the nose section includes a pocket, and wherein the conveyor is a gathering chain.

17. The process line of claim 15, wherein the process line is a binding line, the nose is a binder nose, and the conveyor is a gathering raceway.

18. The process line of claim 15, wherein the process line is an offline mailer, wherein the nose includes a registration portion and a printing portion.

19. The process line of claim 15, wherein the transfer section includes a delivery section operable to deliver the printed product to the nose section, and wherein the delivery section at least partially supports the nose section.

20. The process line of claim 14, wherein the post includes a hitch location and wherein the loader is alignable with the hitch location to position the loader relative to the process line.

21. The process line of claim 14, wherein the post includes connections to a production support supply.

22. The process line of claim 21, wherein the production support supply includes at least one of air, vacuum, power and communications.

23. A process line comprising:
a conveyor;
a plurality of loaders operable to deliver product to the conveyor; and
a support post positioned adjacent the conveyor and operable to selectively receive the plurality of loaders and align each loader with respect to the conveyor.

24. The process line of claim 23, wherein each loader includes a buffer section operable to support a quantity of product, a transfer section operable to receive product from the buffer section and individualize the product, and one of a plurality of interchangeable nose sections receiving the single product and delivering it to the conveyor.

25. The process line of claim 23, wherein the post includes connections to a production support supply.

26. The process line of claim 25, wherein the production support supply includes at least one of air, vacuum, power and communications.

27. A method of arranging a process line including a conveyor operable to move product, the method comprising:
positioning a support post adjacent a conveyor line; and
coupling a loader to the post such that the loader is operable to deliver product to the conveyor.

28. The method of claim 27, wherein the post includes a hitch location and the step of coupling the loader to the post includes connecting the loader to the hitch location to thereby align the loader to the conveyor.

29. The method of claim 27, wherein the post includes a production supply connection supplying one of pressurized air, vacuum, power and communications to the loader.

30. The method of claim 27, wherein the post extends substantially the length of the conveyor.

31. The method of claim 27, wherein the post includes at least two supply connections, each supply connection providing at least one of pressurized air, vacuum, power and communications to one of the loaders.

32. A support post positioned adjacent a conveyor of a finishing line, the support post comprising:
an alignment member positioned a distance from a conveyor, the alignment member operable to engage and align a loader relative to the conveyor.

33. The support post of claim 32, wherein the alignment member includes a hitch location that engages and positions the loader relative to the conveyor line.

34. The support post of claim 32, further comprising a second hitch location, the second hitch location spaced apart from the hitch location and operable to engage and position a second loader a distance from the conveyor line.

35. The support post of claim 32, wherein the alignment member aligns a plurality of loaders such that the loaders are operable to deliver product to the conveyor line.

36. A support post positioned adjacent a conveyor of a finishing line, the support post comprising:
an alignment member operable to engage a loader;
a production supply line adjacent the alignment member and operable to provide at least one of pressurized air, vacuum, power and communications to a loader engaged by the alignment member.

37. The support post of claim 36, wherein the alignment member includes a substantially hollow portion and the production supply line extends at least partially within the hollow portion.

38. The support post of claim 36, further comprising a second production supply line and a third production supply line, wherein the first production supply line delivers pressurized air to the loader, the second production supply line delivers vacuum to the loader, and the third production supply line delivers power and communications to the loader.

39. The support post of claim 38, wherein the alignment member is operable to align a second loader, the second loader receiving pressurized air from the first production supply line, vacuum from the second production supply line, and power and communications from the third production supply line.
